(19) United States
(12) Patent Application Publication
(10) Pub. No.: US 2025/0016688 A1
(43) Pub. Date: Jan. 9, 2025

(54) SYSTEMS, METHODS, AND NON-TRANSITORY PROCESSOR-READABLE MEDIA FOR TRANSMISSION POWER DETERMINATION

(71) Applicant: ZTE CORPORATION, Shenzhen (CN)

(72) Inventors: Xing LIU, Shenzhen (CN); Junfeng ZHANG, Shenzhen (CN); Xianghui HAN, Shenzhen (CN); Chunli LIANG, Shenzhen (CN); Shuaihua KOU, Shenzhen (CN); Jian LI, Shenzhen (CN)

(73) Assignee: ZTE CORPORATION, Shenzhen (CN)

(21) Appl. No.: 18/891,185

(22) Filed: Sep. 20, 2024

Related U.S. Application Data
(63) Continuation of application No. PCT/CN2022/130097, filed on Nov. 4, 2022.

(51) Int. Cl. H04W 52/14; H04W 24/10; H04W 52/36; H04W 74/0833

(52) U.S. Cl. CPC H04W 52/146; H04W 24/10; H04W 52/36; H04W 74/0833

(57) ABSTRACT

Systems, methods, non-transitory processor-readable media, and apparatuses for determining, by a wireless communication device, a transmission power for multiple Physical Random Access Channel (PRACH) transmissions in a PRACH transmission bundle and transmitting, by the wireless communication device to a base station, the multiple PRACH transmissions using the transmission power.

### CROSS-REFERENCE TO RELATED APPLICATION

This application claims the benefit of priority under 35 U.S.C. § 120 as a continuation of International Patent Application No. PCT/CN2022/130097, filed on Nov. 4, 2022, the disclosure of which is incorporated herein by reference in its entirety.

### TECHNICAL FIELD

The disclosure relates generally to wireless communications and, more particularly, to systems, methods, and non-transitory processor-readable media for transmission power determination.

### BACKGROUND

Currently, the first phase standardization of the 5th Generation Mobile Communication Technology (5G) has already completed. A series features have been specified in the first three New Radio (NR) releases, e.g., Rel-15, Rel-16, and Rel-17. Coverage is an important factor in implementing cellular communication networks due to its direct impact on service quality as well as capital expenditure (CAPEX) and operational expenditure (OPEX). Despite the importance of coverage on the success of NR implementation, a thorough coverage evaluation and a comparison with legacy Radio Access Technologies (RATs) considering all NR specification details have not been performed until now.

### SUMMARY

In some arrangements, systems, methods, apparatuses, and non-transitory computer-readable media for determining, by a User Equipment (UE), a transmission power for multiple Physical Random Access Channel (PRACH) transmissions in a PRACH bundle and transmitting, by the UE to a base station, the multiple PRACH transmissions using the transmission power.

In some arrangements, systems, methods, apparatuses, and non-transitory computer-readable media for sending, by a base station to a UE, a parameter used by the wireless communication device to determine a transmission power for transmitting multiple PRACH transmissions in a PRACH bundle, and receiving, by the base station from the UE, the multiple PRACH transmissions based on the transmission power.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 is a diagram illustrating an example cellular communication network, in accordance with some arrangements.

FIG. 2 illustrates block diagrams of an example base station and an example user equipment device, in accordance with some arrangements.

FIG. 3 illustrates an example scheme implemented for supporting the initial access.

FIG. 4 is a flowchart diagram illustrating an example method for determining transmission power for multiple PRACH transmissions, according to various arrangements.

FIG. 5 is a table illustrating an example mapping relationship between preamble formats and different sets of DELTA_PREAMBLE for multiple PRACH transmissions (including retransmissions/repetitions) and single PRACH transmission for a PRACH attempt, according to various arrangements.

FIG. 6 is a table illustrating example PREAMBLE_RECEIVED_TARGET_POWER determined based on a first counter for counting or recording the number of PRACH repetitions and a second counter for counting or recording the number of PRACH attempts, according to various arrangements.

FIG. 7 is a table illustrating example PREAMBLE_RECEIVED_TARGET_POWER determined based on a first counter for counting or recording the number of PRACH repetitions and a second counter for counting or recording the number of PRACH attempts, according to various arrangements.

FIG. 8 is a diagram illustrating SSB-RSRP power thresholds corresponding to PRACH repetition factors, according to some arrangements.

FIG. 9 is a table illustrating an example relationship between msg3-DeltaPreamble, the repetition factor for PRACH, and the repetition factor for Msg3, according to some arrangements.

FIG. 10 is a block diagram of Discrete Fourier Transform Spread Orthogonal Frequency Division Multiplexing (DFT-S-OFDM) transmitter with FDSS and spectrum extension, according to some arrangements.

FIG. 11 is a diagram illustrate an example of resources, according to various arrangements.

FIG. 12 is a diagram illustrate an example of resources, according to various arrangements.

FIG. 13 is a table listing the possible values of extension factor that can be configured for the different value of N, according to various arrangements.

FIG. 14 is a table listing the possible values of extension factor that can be configured for the different value of N, according to various arrangements.

FIG. 15 is a table illustrating the MCS index table for PUSCH with transform precoding (also known as DFT-s-OFDM PUSCH), according to various arrangements.

FIG. 16 is a table illustrating relationship between MCS index and extension factors, according to various arrangements.

FIG. 17 is a table illustrating relationship between MCS index and extension factors, according to various arrangements.

FIG. 18 is a table illustrating relationship between MCS index and extension factors, according to various arrangements.

FIG. 19 is a code-point table, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

Among physical channels used during initial access procedures and handover procedures, Physical Random Access Channel (PRACH) which requests uplink allocation for sending uplink data to the base station is a potential coverage bottleneck. The arrangements disclosed herein relate to improving the coverage of PRACH, and in particular, to the repetition transmissions of PRACH. The arrangements disclosed herein relate to determining transmission power for each PRACH repetition transmission.

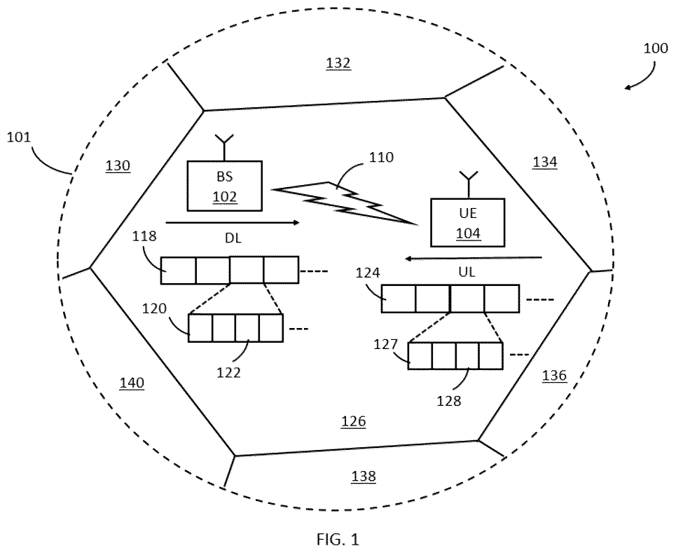

FIG. 1 illustrates an example wireless communication system 100, in accordance with an arrangement of the present disclosure. In the following discussion, the wireless communication system 100 may be any wireless network, such as a cellular network or a narrowband network. The system 100 includes a base station 102 and a UE 104 that can communicate with each other via a communication link 110 (e.g., a wireless communication channel), and a cluster of cells, e.g., at least 126, 130, 132, 134, 136, 138 and 140 overlaying a geographical area 101. In FIG. 1, the base station 102 and UE 104 are shown to be located within a respective geographic boundary of cell 126. Each of the other cells 130, 132, 134, 136, 138 and 140 may include at least one base station operating at its allocated bandwidth to provide adequate radio coverage to its intended users.

For example, the base station 102 may operate at an allocated channel transmission bandwidth to provide adequate coverage to the UE 104. The base station 102 and the UE 104 may communicate via a downlink radio frame 118, and an uplink radio frame 124 respectively. Each radio frame 118/124 may be further divided into subframes (or slots) 120/127 which may include data symbols 122/128. In the present disclosure, the base station 102 and UE 104 are described herein as non-limiting examples of communication nodes, generally, which can practice the methods disclosed herein. Such communication nodes may be capable of wireless and/or wired communications, in accordance with various arrangements of the present solution.

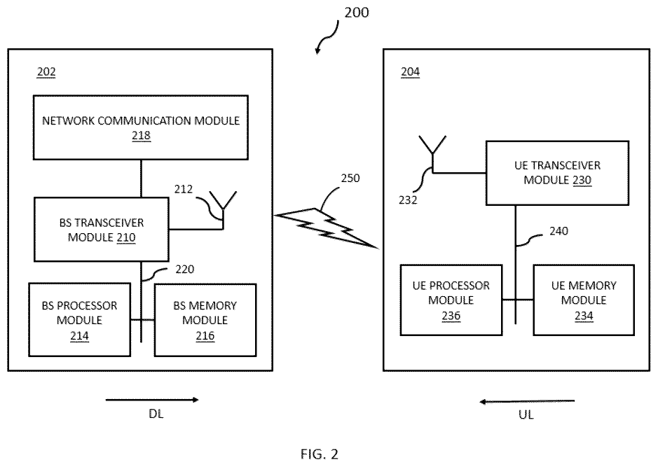

FIG. 2 illustrates a block diagram of an example wireless communication system 200 for transmitting and receiving wireless communication signals, in accordance with some arrangements. The system 200 may include components and elements configured to support known or conventional operating features that need not be described in detail herein. In some arrangements, system 200 can be used to communicate (e.g., transmit and receive) data symbols in a wireless communication environment such as the wireless communication system 100 of FIG. 1, as described above.

The system 200 generally includes a base station 202 and a UE 204. The base station 202 includes a base station transceiver module 210, a base station antenna 212, a base station processor module 214, a base station memory module 216, and a network communication module 218, each module being coupled and interconnected with one another as necessary via a data communication bus 220. The UE 204 includes a UE transceiver module 230, a UE antenna 232, a UE memory module 234, and a UE processor module 236, each module being coupled and interconnected with one another as necessary via a data communication bus 240. The base station 202 communicates with the UE 204 via a communication channel 250, which can be any wireless channel or other medium suitable for transmission of data as described herein.

The system 200 may further include any number of modules other than the modules shown in FIG. 2. The various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some arrangements, the UE transceiver 230 may be referred to herein as an uplink transceiver 230 that includes a Radio Frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some arrangements, the base station transceiver 210 may be referred to herein as a downlink transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some arrangements, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative arrangements, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various arrangements, the base station 202 may be an gNB, evolved node B (eNB), a serving eNB, a target eNB, a femto station, or a pico station, for example. In some arrangements, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the arrangements disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some arrangements, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

In some examples, FIG. 3 illustrates an example scheme 300 implemented for supporting the initial access (e.g., PRACH procedure) under frequency ranges FR1 (e.g., sub-6G Hz band) and frequency range FR2 (e.g., beyond 6G Hz band). In FIG. 3, the base station communications 301 (e.g., beamforming) of a base station (e.g., the base station 102, 202) can be shown on the top rail while UE communications 302 (e.g., beamforming) of a UE (e.g., the UE 104, 204) can be shown on the bottom rail. The transmission of PRACH for example can be transmitted via Msg1 310. The scheme 300 further includes different PRACH formats, PRACH resource configurations, the relationship between the Synchronization Signal/Physical Broadcasting Channel (PBCH) Block (SSB) and PRACH occasion, the mechanism of PRACH retransmission, the mechanism of PRACH power control, and so on.

The shaded beams in FIG. 3 are beams used to transmit or receive data. As shown in FIG. 3, the UE transmits a preamble in PRACH Occasion (RO), according to the configuration of PRACH transmission and a selected SSB. In transmitting the preamble in RO, if the transmit-receive correspondence on the UE-side can be guaranteed, a fixed mapping between the UE's receiving (Rx) beam and the UE's transmitting (Tx) beam can be used. A unique Tx beam can be determined according to its receiving of the SSB. For example, the UE can attempt to use different Rx beams 303 to receive the SSB from the base station (e.g., at 305), and determine the best Rx beam 304. In some arrangements, the best Rx beam 304 (e.g., the best downlink Rx beam) is a beam with the highest Reference Signal Received Power (RSRP). According to the best Rx beam 304, the best Tx beam 306 (e.g., best uplink Tx beam) is determined based on beam correspondence. The RO used for transmitting the PRACH is determined according to the relationship between the SSB and PRACH occasion. Based on the relationship, the base station can determine the SSB selected by the UE. The same beam 315 can be used for transmitting subsequent downlink transmissions, including, Msg2 320 (which can also be referred to as Random Access Response (RAR) and Msg4 340. According to a RACH procedure, the RAR (e.g., Msg2 320) is communicated after the end of PRACH transmission (e.g., Msg1 310). The RAR window starts at the first symbol of the earliest Control Resource Set (CORESET) for which the UE is configured to receive Physical Downlink Control Channel (PDCCH) for Type1-PDCCH Common Search Space (CSS) set, that is at least a predefined number of time units (e.g., symbols) after the last symbol of the PRACH occasion corresponding to the PRACH transmission.

In the example in which a UE transmits the PRACH and fails to receive the corresponding RAR within the RAR window, the UE considers that the RACH procedure has failed. The UE re-initializes the RACH procedure in response to the failure. That is, the UE retransmits the preamble at a higher transmission power to increase the subsequent access success rate of the RACH procedure.

For PRACH transmission without repetition, the transmission power P_{PRACH,b,f,c}(i) on active Uplink (UL) Bandwidth Part (BWP) b of carrier f of serving cell c is determined using:

$${P}_{PRACH , b , f , c} ( i ) = min \{ {P}_{CMAX , f , c} ( i ) , {P}_{PRACH , target , f , c} + {PL}_{b , f , c} \} [ dBm ] , \qquad ( 1 )$$

where P_{CMAX,f,c}(i) is the UE configured maximum output power for carrier f of serving cell c within transmission occasion i, P_{PRACH,target,f,c} is the PRACH target reception power (e.g., PREAMBLE_RECEIVED_TARGET_POWER, also referred to as determined preamble received target power) provided by higher layers for the active UL BWP b of carrier f of serving cell c, and PL_{b,f,c} is a pathloss for the active UL BWP b of carrier f based on the DL RS associated with the PRACH transmission on the active DL BWP of serving cell C and calculated by the UE. In some examples, the PREAMBLE_RECEIVED_TARGET_POWER is set to:

$$preambleRecievedTargetPower + DELTA\_PREAMBLE + ( PREAMBLE\_POWER \_RAMPING \_COUNTER - 1 ) \times PREAMBLE\_POWER \_RAMPING \_STEP + POWER\_OFFSET \_ 2 STEP\_RA , \qquad ( 2 )$$

where preambleReceivedTargetPower (referred to as configured preamble received target power) is preamble received target power configured by a base station via RRC signaling. The DELTA_PREAMBLE e values corresponding to different preamble formats. PREAMBLE_POWER_RAMPING_COUNTER is a counter that records the number of PRACH transmissions. PREAMBLE_POWER_RAMPING_STEP is the power increase for each retransmission configured by a base station via RRC signaling. For example, the value of PREAMBLE_POWER_RAMPING_STEP can be configured as 3 dB, the power of the first PRACH transmission is N dBm, the power of the first retransmission of PRACH (or the second PRACH transmission) can be N+3 dB. POWER_OFFSET_2STEP_RA is used for 2-step RACH transmission, which has a value of 0 under 4-step RACH procedure.

PRACH transmissions including at least one repetition can also be referred to as multiple PRACH transmissions or PRACH repetitions. In some examples, multiple PRACH transmissions can be referred to as a PRACH attempt or a PRACH transmission bundle. The multiple PRACH transmissions in a PRACH attempt or PRACH transmission bundle are transmission for a single PRACH process, which can be determined to be successful or failed. The number of PRACH transmissions within one PRACH attempt or one PRACH transmission bundle is referred to as a PRACH repetition factor. For example, the PRACH repetition factor can be configured by a base station as 2, 4, or 8, indicating that one PRACH attempt or one PRACH transmission bundle includes 2, 4, or 8 times or instances of PRACH transmissions, e.g., 2, 4, or 8 PRACH repetitions.

The arrangements disclosed herein relate to determining transmission power for each PRACH repetition transmission and determining the relationship between the transmission power for PRACH transmission with at least one repetition and the transmission power for 0 transmission.

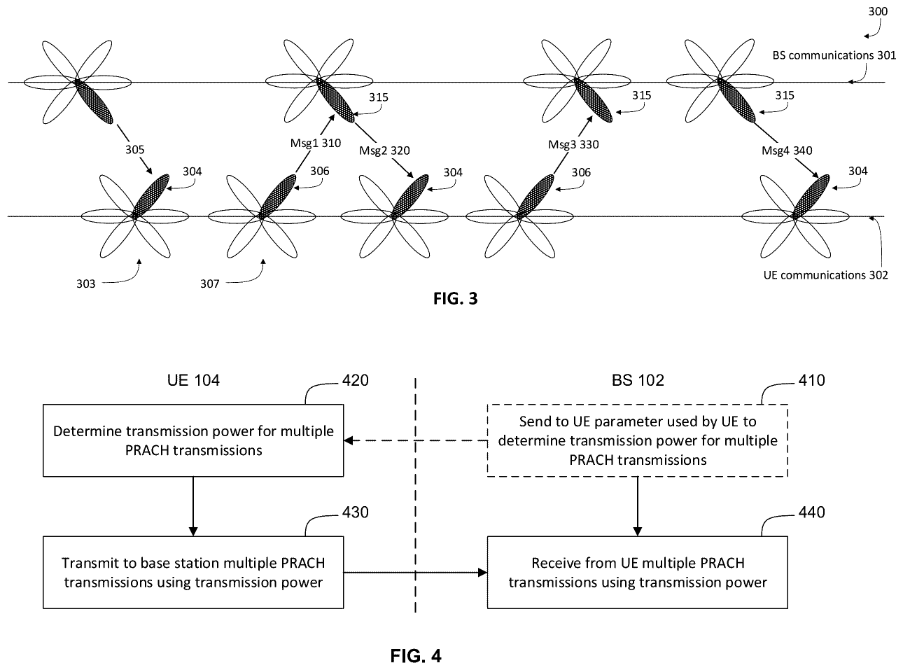

FIG. 4 is a flowchart diagram illustrating an example method for determining transmission power for multiple PRACH transmissions, according to various arrangements. The method can be performed by the base station 102 and the UE 104, according to various arrangements.

At 420, the UE 104 determines the transmission power for the multiple PRACH transmissions. In some examples, at 410, the base station 102 sends to the UE at least one parameter used by the UE to determine the transmission power for the multiple PRACH transmissions. The UE 104 can receive the at least one parameter and use the same along with one or more other parameters in determining the transmission power at 420. The transmission power can be determined at 420 according to any of the suitable methods, e.g., those shown in (1)-(10). In some examples, the UE 102 can determine the transmission power without using any parameter received from the base station 102. The at least one parameter includes any indication, value, or parameter sent by the base station 102 to the UE 104 as described herein.

At 430, the UE 104 transmits to the base station 102 the multiple PRACH transmissions using the determined transmission power. At 440, the base station 102 receives from the UE 104 the multiple PRACH transmissions. In some arrangements, the multiple PRACH transmissions includes an initial PRACH transmission and at least one repetition or at least one retransmissions of the initial PRACH transmission in the same PRACH transmission bundle.

In some arrangements, the base station can configure a configured PRACH target reception power for multiple PRACH transmissions and send to the UE a parameter indicating the configured PRACH target reception power configured for multiple PRACH transmissions (with at least one repetition or retransmission) in a PRACH transmission bundle. For example, this parameter (e.g., preambleReceivedTargetPower) can be configured via RRC signaling for multiple PRACH transmissions. In addition, this parameter is independent of and different from the configured PRACH target reception power for single PRACH transmission (e.g., PRACH transmission without repetition). In other words, there are two parameters for indicating the configured PRACH target reception power for multiple PRACH transmissions and single PRACH transmission, respectively.

In some arrangements, the base station can configure a configured PRACH target reception power specific to each PRACH repetition factor of the multiple PRACH transmissions and send to the UE a parameter indicating the configured PRACH target reception power configured for each PRACH repetition factor of the multiple PRACH transmissions (with at least one repetition or retransmission) in a PRACH transmission bundle. For example, a PRACH target repetition power is configured by the base station for each PRACH repetition factor. In the example in which there are three different PRACH repetition factors for the multiple PRACH transmissions in a PRACH transmission bundle in total, three values of the PRACH target repetition power are configured by the base station for the different PRACH repetition factors, respectively, and are transmitted to the UE.

In some arrangements, in the method shown in FIG. 4, determining the transmission power for the multiple PRACH transmissions includes receiving, by the UE 104 from the base station 102, an indication of a configured target reception power for the multiple PRACH transmissions. Transmitting the multiple PRACH transmissions using the transmission power includes transmitting the multiple PRACH transmissions according to the transmission power determined based on the configured target reception power for the multiple PRACH transmissions.

In some examples, in the method shown in FIG. 4, the target reception power for the multiple PRACH transmissions includes a same configured target reception power configured for multiple repetition factors, each of the multiple repetition factors indicates a different number of transmissions of the multiple PRACH transmissions in the PRACH transmission bundle. In some examples, the target reception power for the multiple PRACH transmissions includes a configured target reception power configured for each of the multiple repetition factors of the multiple PRACH transmissions.

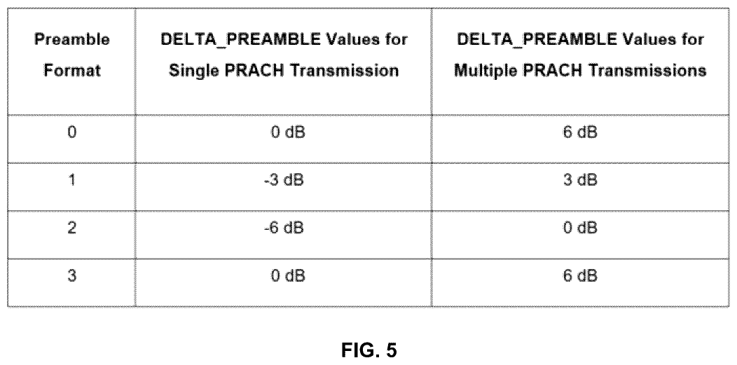

In some arrangements, a set of values of DELTA_PREAMBLE (e.g., a set of delta values) is defined for determining the transmission power for transmitting multiple PRACH transmissions in a PRACH transmission bundle. This set of values are independent of and different from that for a single PRACH transmission (e.g., PRACH transmission without repetition). In other words, there are two sets DELTA_PREAMBLE values for multiple PRACH transmissions and single PRACH transmission, respectively. FIG. 5 is a table illustrating an example mapping relationship between preamble formats and different sets of DELTA_PREAMBLE for multiple PRACH transmissions (including retransmissions/repetitions) and single PRACH transmission for a PRACH transmission bundle.

In some arrangements, in the method shown in FIG. 4, the transmission power for the multiple PRACH transmissions is determined using a set of delta values (e.g., DELTA_PREAMBLE) for the multiple PRACH transmissions, the set of delta values corresponding to preamble formats. Transmitting the multiple PRACH transmissions using the transmission power includes transmitting the multiple PRACH transmissions according to the transmission power determined based on the set of delta values.

In some arrangements, the set of DELTA_PREAMBLE values for multiple PRACH transmissions can be determined according to the set of DELTA_PREAMBLE values for the single PRACH transmission for the PRACH transmission bundle. That is, in the method shown in FIG. 4, the set of delta values for the multiple PRACH transmissions is determined using a set of delta values for a single PRACH transmission in a PRACH transmission bundle and an offset. For example, a offset (e.g., X dB) is configured by the base station and sent to the UE or is predefined. The DELTA_PREAMBLE value for multiple PRACH transmissions can be determined by adding X to the DELTA_PREAMBLE value for single PRACH transmission with for each respective preamble format. In the example in which X=6 dB, for preamble format 0, the DELTA_PREAMBLE value for multiple PRACH transmissions for preamble format 0 can be determined as X+0=6 dB, where the DELTA_PREAMBLE value for the single PRACH transmissions for preamble format 0 is 0 as shown in FIG. 5.

In some arrangements, the base station can configure a set of DELTA_PREAMBLE values specific to each PRACH repetition factor of the multiple PRACH transmissions and send to the UE a parameter indicating the set of DELTA_PREAMBLE values configured for each PRACH repetition factor of the multiple PRACH transmissions (with at least one repetition or retransmission) in a PRACH transmission bundle. In the example in which there are three different PRACH repetition factors for the multiple PRACH transmissions in a PRACH transmission bundle in total, three sets of DELTA_PREAMBLE values are configured by the base station for the different PRACH repetition factors, respectively, and are transmitted to the UE. In some examples, in the method shown in FIG. 4, the set of delta values for the multiple PRACH transmissions includes a same set of delta values configured for multiple repetition factors, each of the multiple repetition factors indicates a different number of transmissions of the multiple PRACH transmissions in the PRACH transmission bundle, or a set of delta values configured for each of the multiple repetition factors of the multiple PRACH transmissions.

In some arrangements, an additional power offset (e.g., POWER_OFFSET_MULTIPLEPRACH) can introduced in the calculation formula of PREAMBLE_RECEIVED_TARGET_POWER for multiple PRACH transmissions. For PRACH transmission with at least one repetition or retransmission, the power offset parameter can be used for adjusting the calculation result. For example, PREAMBLE_RECEIVED_TARGET_POWER used in (1) can be determined by:

$$preambleRecievedTargetPower + DELTA\_PREAMBLE + ( PREAMBLE\_POWER \_RAMPING \_COUNTER - 1 ) \times PREAMBLE\_POWER \_RAMPING \_STEP + POWER\_OFFSET \_ 2 STEP\_RA + POWER\_OFFSET \_MULTIPLEPRACH . \qquad ( 3 )$$

where POWER_OFFSET_MULTIPLEPRACH can be configured via RRC signaling by the base station to the UE or predefined for the multiple PRACH transmissions for the RACH transmission bundle. For a single PRACH transmission for the PRACH transmission bundle, the value of POWER_OFFSET_MULTIPLEPRACH is 0.

In some arrangements, in the method shown in FIG. 4, the transmission power for the multiple PRACH transmissions is determined using a power offset for the multiple PRACH transmissions, Transmitting the multiple PRACH transmissions using the transmission power includes transmitting the multiple PRACH transmissions according to the transmission power determined based on the power offset.

In some arrangements, station can configure the the base POWER_OFFSET_MULTIPLEPRACH value specific to each PRACH repetition factor of the multiple PRACH transmissions and send to the UE a parameter indicating the POWER_OFFSET_MULTIPLEPRACH value configured for each PRACH repetition factor of the multiple PRACH transmissions (with at least one repetition or retransmission) in a PRACH transmission bundle. In the example in which there are three different PRACH repetition factors for the multiple PRACH transmissions in a PRACH transmission bundle in total, three sets of POWER_OFFSET_MULTIPLEPRACH values are configured by the base station for the different PRACH repetition factors, respectively, and are transmitted to the UE. In some arrangements, in the method shown in FIG. 4, the power offset for the multiple PRACH transmissions includes a same power offset configured for multiple repetition factors, each of the multiple repetition factors indicates a different number of transmissions of the multiple PRACH transmissions in the PRACH transmission bundle, or a power offset configured for each of the multiple repetition factors of the multiple PRACH transmissions.

In some arrangements, for a single PRACH transmission, the power ramping counter (e.g., PREAMBLE_POWER_RAMPING_COUNTER) is used for recording the number of PRACH transmissions or PRACH transmission bundles. For multiple PRACH transmissions, a PRACH transmission bundle includes two or more PRACH transmissions. For multiple PRACH transmissions within a PRACH transmission bundle, the transmission power can be same for each of the PRACH transmissions. The power ramping counter (e.g., PREAMBLE_POWER_RAMPING_COUNTER) can also be used for recording the number of PRACH transmission bundles. The PREAMBLE_RECEIVED_TARGET_POWER (e.g., the determined preamble received target power) can be determined according to the PRACH repetition factor. For example, PREAMBLE_RECEIVED_TARGET_POWER can be determined using one of:

$$preambleRecievedTargetPower + DELTA\_PREAMBLE + ( PREAMBLE\_POWER \_RAMPING \_COUNTER \times Factor - 1 ) \times PREAMBLE\_POWER \_RAMPING \_STEP + POWER\_OFFSET \_ 2 STEP\_RA ; \qquad ( 4 )$$

$$preambleRecievedTargetPower + DELTA\_PREAMBLE + ( PREAMBLE\_POWER \_RAMPING \_COUNTER \times Factor - 1 ) \times PREAMBLE\_POWER \_RAMPING \_STEP ; \qquad ( 5 )$$

$$preambleRecievedTargetPower + DELTA\_PREAMBLE + ( PREAMBLE\_POWER \_RAMPING \_COUNTER \times Factor ) \times PREAMBLE\_POWER \_RAMPING \_STEP + POWER\_OFFSET \_ 2 STEP\_RA ; \qquad ( 6 )$$

$$preambleRecievedTargetPower + DELTA\_PREAMBLE + ( PREAMBLE\_POWER \_RAMPING \_COUNTER \times Factor ) \times PREAMBLE\_POWER \_RAMPING \_STEP ; \qquad ( 7 )$$

$$preambleRecievedTargetPower + DELTA\_PREAMBLE + ( PREAMBLE\_POWER \_RAMPING \_COUNTER - 1 ) \times PREAMBLE\_POWER \_RAMPING \_STEP \times Factor + POWER\_OFFSET \_ 2 STEP\_RA ; \qquad ( 8 )$$

$$preambleRecievedTargetPower + DELTA\_PREAMBLE + ( PREAMBLE\_POWER \_RAMPING \_COUNTER - 1 ) \times PREAMBLE\_POWER \_RAMPING \_STEP \times Factor , \qquad ( 9 )$$

where, Factor represents PRACH repetition factors or the number of PRACH transmission within a PRACH transmission bundle. In some arrangements, in the method shown in FIG. 4, the transmission power for the multiple PRACH transmissions is determined using a repetition factor for the multiple PRACH transmissions. The repetition factor indicates a number of transmissions of the multiple PRACH transmissions in the PRACH transmission bundle.

In some arrangements, the transmission power for each PRACH repetition transmission in a PRACH transmission bundle can be determined. For a single PRACH transmission, a power ramping counter (e.g., PREAMBLE_POWER_RAMPING_COUNTER) is used, and a power ramping step size (e.g., PREAMBLE_POWER_RAMPING_STEP) is configured. For multiple PRACH transmissions in a PRACH transmission bundle, an independent power ramping counter can be introduced. In other words, two independent or different power ramping counters can be used for multiple PRACH transmissions. As an example, a first power ramping counter C1 represents power ramping counter for counting within a same PRACH transmission bundle and recording a current number of PRACH repetitions, and a second power ramping counter C2 represents power ramping counter for counting and recording a current number of PRACH transmission bundles. In some arrangements, in the method shown in FIG. 4, the transmission power for the multiple PRACH transmissions is determined using a first power ramping counter (e.g., C1) and a second power ramping counter (e.g., C2), the first power ramping counter counts a current number of the multiple PRACH transmissions, and the second power ramping counter counts a current number of PRACH transmission bundles.

In some arrangements, an independent or different power ramping step size can be defined between PRACH repetitions within the same PRACH transmission bundle or across different PRACH transmission bundles. In other words, two independent or different power ramping step sizes can be defined or configured by the base station for multiple PRACH transmissions. In some examples, the power ramping step size between different transmissions within the same PRACH transmission bundle can be P1, and the power ramping step size between PRACH transmissions different PRACH transmission bundles can be P2.

In some arrangements, PREAMBLE_RECEIVED_TARGET_POWER can be determined according to the power ramping step sizes P1 and P2 and power ramping counters C1 and C2. For example, PREAMBLE_RECEIVED_TARGET_POWER can determined by:

$$preambleReceivedTargetPower + DELTA\_PREAMBLE + ( C 1 - 1 ) \times P 1 + ( C 2 - 1 ) \times P 2. \qquad ( 10 )$$

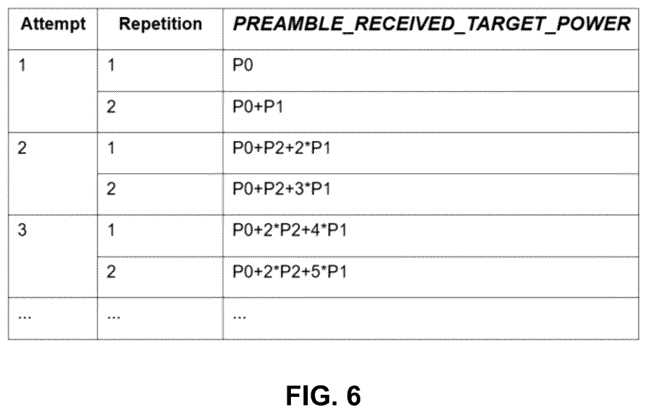

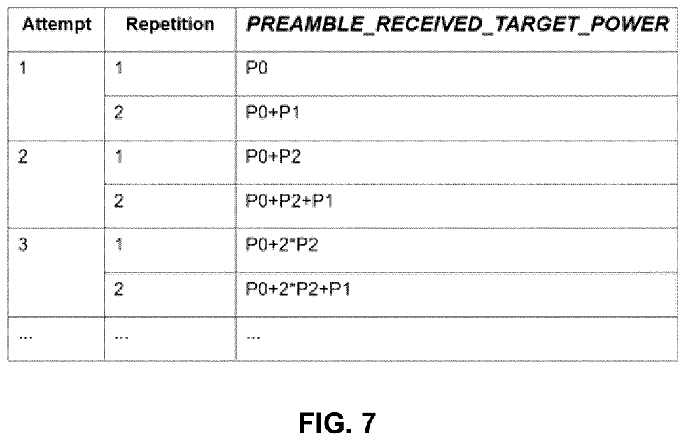

FIG. 6 is a table illustrating example PREAMBLE_RECEIVED_TARGET_POWER determined using expression (10) based on a counter C1 for counting or recording the number of PRACH repetitions and a counter C2 for counting or recording the number of PRACH transmission bundles. FIG. 7 is a table illustrating example PREAMBLE_RECEIVED_TARGET_POWER determined using expression (10) based on a counter C1 for counting or recording the number of PRACH repetitions and a counter C2 for counting or recording the number of PRACH transmission bundles. FIGS. 6 and 7 illustrate the determined PREAMBLE_RECEIVED_TARGET_POWER based on the number of repetitions across different PRACH transmission bundles.

In some arrangements, in the method shown in FIG. 4, the transmission power for the multiple PRACH transmissions is determined using a first power ramping step size and a second power ramping step size. The first power ramping step size is a difference between two adjacent PRACH transmissions within the PRACH transmission bundle. Two adjacent PRACH transmissions do not have another PRACH transmission between. The second power ramping step size is a difference between a first PRACH transmission in the PRACH transmission bundle and a second PRACH transmission in another PRACH transmission bundle. In some example, the first PRACH transmission in the PRACH bundle is the last PRACH transmission (in time) in the first PRACH bundle, and the second PRACH transmission in another PRACH bundle is the first PRACH transmission (in time) in the second PRACH bundle. In some examples, the first PRACH bundle and the second PRACH bundle are two adjacent PRACH bundles, and the first PRACH bundle is before the second PRACH bundle in time.

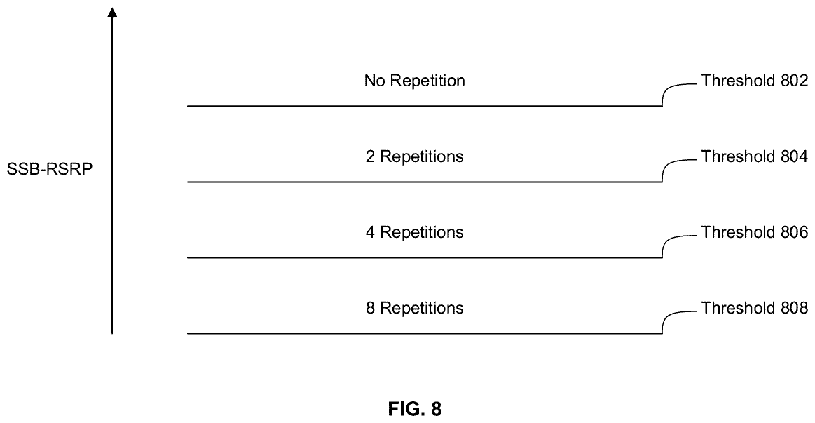

In some arrangements, the transmission power for each PRACH repetition transmission in a PRACH transmission bundle can be determined. FIG. 8 is a diagram illustrating SSB-RSRP thresholds 802, 804, 806, and 808 (e.g., power thresholds) corresponding to PRACH repetition factors, according to some arrangements. At least one SSB-RSRP threshold (e.g., threshold 802) can be used by the UE to determine whether to enter the PRACH repetition mode.

In some arrangements, in response to the UE determining that the SSB-RSRP measurement result of the UE is higher than or equal to the 802, the UE uses a single PRACH transmission. In response to the UE determining that the PRACH transmission power reaches the maximum value or the retransmission of PRACH reach a predefined number (e.g., configured by the base station via RRC signaling or predefined), and that the RACH process has fails, the UE initiates the PRACH procedure in repetition mode in which the UE transmits PRACH with at least one repetition in a subsequent RACH procedure, in response to the failure.

In some arrangements, if a UE selects the single PRACH transmission at the first attempt, but initial access fails after multiple PRACH re-attempts, the UE is better to directly use multiple PRACH transmissions when it initiates new PRACH transmission. The preambleTransMax (e.g., X) can be reused as a threshold for UE to initiate the multiple PRACH transmissions. If the number of PRACH attempts exceeds the preambleTransMax and initial access failure is declared, UE would try the multiple PRACH transmissions afterwards. Or a new parameter less than preambleTransMax can be configured as the threshold of single PRACH attempts for UE to initiate the multiple PRACH transmissions before the initial access failure is declared. Or a new parameter, e.g., coefficient θ is configured, and θ×X′ is defined as the threshold of single PRACH attempts for UE to initiate the multiple PRACH transmissions. Wherein, 0<θ≤1.

In some arrangements, in response to the UE determining that SSB-RSRP measurement result of the UE is lower than the threshold 802, the UE initiates the repetition mode (e.g., transmitting PRACH with at least one repetition), and the PRACH repetition factor can be determined by the UE. In some arrangements, a plurality of thresholds (e.g., thresholds 804, 806, and 808) can be predefined or configured/sent by the base station to the UE to assist the UE in determining different repetition factors. For example, in response to the UE determining that SSB-RSRP measurement result of the UE is between the thresholds 802 and 804, the UE implements PRACH repetition factor 2 (e.g., 2 transmissions) within the PRACH transmission bundle. In response to the UE determining that SSB-RSRP measurement result of the UE is between the thresholds 804 and 806, the UE implements PRACH repetition factor 4 (e.g., 4 transmissions) within the PRACH transmission bundle. In response to the UE determining that SSB-RSRP measurement result of the UE is between the thresholds 806 and 808, the UE implements PRACH repetition factor 8 (e.g., 8 transmissions) within the PRACH transmission bundle. In response to determining that the initial power of the UEs does not reach the maximum value, the UE increases the power between different repetitions within the same PRACH transmission bundle to increase the access probability and reduce the access delay.

In some arrangements, in response to the UE determining that SSB-RSRP measurement result of the UE is lower than the threshold 802, the UE initiates the repetition mode (e.g., transmitting PRACH with at least one repetition) and transmits the multiple PRACH transmissions using maximum transmit power. In some arrangements, the UE can determine the repetition factor. In some arrangements, a plurality of thresholds (e.g., thresholds 804, 806, and 808) can be predefined or configured/sent by the base station to the UE to assist the UE in determining different repetition factors. For example, in response to the UE determining that SSB-RSRP measurement result of the UE is between the thresholds 802 and 804, the UE implements PRACH repetition factor 2 (e.g., 2 transmissions) within the PRACH transmission bundle. In response to the UE determining that SSB-RSRP measurement result of the UE is between the thresholds 804 and 806, the UE implements PRACH repetition factor 4 (e.g., 4 transmissions) within the PRACH transmission bundle. In response to the UE determining that SSB-RSRP measurement result of the UE is between the thresholds 806 and 808, the UE implements PRACH repetition factor 8 (e.g., 8 transmissions) within the PRACH transmission bundle. In some examples, in the method shown in FIG. 4, determining the transmission power includes determining that a measurement result is less than a threshold (e.g., the threshold 802). In response to determining that the measurement result is less than the threshold, the UE determines to send the multiple PRACH transmissions in the PRACH transmission bundle using a maximum transmit power.

In some arrangements, the relationship between the transmission power for multiple PRACH transmissions within the same PRACH transmission bundle (e.g., PRACH transmission with repetition) and the transmission power for Msg.3 transmission (e.g., a Physical Uplink Shared Channel (PUSCH)) can be defined.

In some arrangements, for multiple PRACH transmissions in the PRACH transmission bundle, the UE can determine msg3 transmission power according to the transmission power of the last or previous PRACH transmission of the multiple PRACH transmissions. For example, the UE can use the power of the last PRACH repetition within the last PRACH transmission bundle for transmitting msg3. In some arrangements, the PRACH preamble transmission (e.g., msg1) is transmitted by the UE to the base station. The UE can receive a response (e.g., msg2) from the base station. The UE transmits the PUSCH which is msg3 in an UL grant provided in Msg2. In some arrangements, in the method shown in FIG. 4 includes determining a transmission power for an uplink transmission (e.g., msg3, PUSCH, and so on) according to a transmission power used to transmit a last PRACH transmission of the multiple PRACH transmissions in the PRACH transmission bundle.

In some arrangements, the UE can determine the transmission power for msg3 based on the transmission power of the PRACH transmission indicated by the base station. For example, within the last or previous PRACH transmission bundle, four PRACH transmissions are transmitted by the UE with transmission powers P1, P2, P3 and P4, respectively. The BS can indicate one of the transmission powers P1, P2, P3 and P4 to UE for determining the transmission power for msg3. The BS can send a 2-bit indication included in msg2/RAR, and each value of these 2 bits corresponds to a respective transmission power. For example, 00 corresponds to P1, 01 corresponds to P2, 10 corresponds to P3, and 11 corresponds to P4. In some arrangements, the method shown in FIG. 4 includes determining a transmission power for an uplink transmission (e.g., msg3, PUSCH, and so on) according to an indication received from a base station indicating one of multiple transmission powers used to transmit the multiple PRACH transmissions in the PRACH transmission bundle.

In some examples, the UE can receive from the base station an RRC parameter (e.g., msg3-DeltaPreamble) for indicating the power offset between a PRACH transmission and msg3 transmission. In some examples, the value of the RRC parameter can be configured for different combinations of repetition factors for PRACH repetition and repetition factors for msg3 repetition. For example, FIG. 9 is a table illustrating an example relationship between msg3-DeltaPreamble, the repetition factor for PRACH, and the repetition factor for Msg3, according to some arrangements. Then, for different repetition factor combinations used for PRACH and msg3 transmission, the corresponding A is used as msg3-DeltaPreamble to determine transmission power for msg3. In some arrangements, the method shown in FIG. 4 includes receiving from the base station an offset between a transmission power of one of the multiple PRACH transmissions and a transmission power for an uplink transmission, the offset is mapped to a repetition factor of the multiple PRACH transmissions and a repetition factor of the uplink transmission. The transmission power for the uplink transmission is determined by the UE based on the transmission power of the one of the multiple PRACH transmissions and the offset.

In some arrangements, a scaling factor is defined according to at least one of PRACH repetition factor and msg3 repetition factor. For example, the scaling factor Y is defined as the ratio of PRACH repetition factor M and msg3 repetition factor N, e.g., Y=M/N. The transmission power of msg3 can be determined by the UE according to the scaling factor and msg3-DeltaPreamble. For example, the transmission power of msg3 can be determined using:

$$Transmission Power of msg 3 = Power of PRACH + Scaling factor \times Value of msg 3 - DeltaPreamble . \qquad ( 11 )$$

In some arrangements, the UE can determine the scaling factor Y according to a reference value Q and the ratio of PRACH repetition factor M and msg3 repetition factor N, e.g., Y=Q×(M/N). The transmission power of msg3 can be determined by the UE according to the scaling factor and msg3-DeltaPreamble. For example, the transmission power of msg3 can be determined using:

$$Transmission Power of msg 3 = power of PRACH + scaling factor + value of msg 3 - DeltaPreamble . \qquad ( 12 )$$

In some arrangements, the method shown in FIG. 4 includes determining a scaling factor based on a repetition factor of the multiple PRACH transmissions and a repetition factor of an uplink transmission, and determining the transmission power for the uplink transmission based on the transmission power of the one of the multiple PRACH transmissions and the scaling factor. In some examples, scaling factor is a ratio of the repetition factor of the multiple PRACH transmissions to the repetition factor of the uplink transmission. In some examples, the scaling factor is determined based on the repetition factor of the multiple PRACH transmissions, the repetition factor of the uplink transmission, and a reference value. In some examples, the transmission power for the uplink transmission based on the transmission power of the one of the multiple PRACH transmissions, the scaling factor, and a value of msg3-DeltaPreamble.

The UE transmission power is the most valuable resource in uplink and enhancements to unlock additional uplink power are highly valuable for uplink coverage. One of the possible ways to improve the uplink coverage in the power domain includes the enhancements to reduce the Maximum Power Reduction (MPR) and Peak-to-Average Ratio (PAR) of the transmission signal. Frequency Domain Spectrum Shaping (FDSS) with and without spectrum extension is a promising solution to reduce the MPR and PAR. In the example in which FDSS with spectrum extension is adopted, the extension factor can be indicated as described herein.

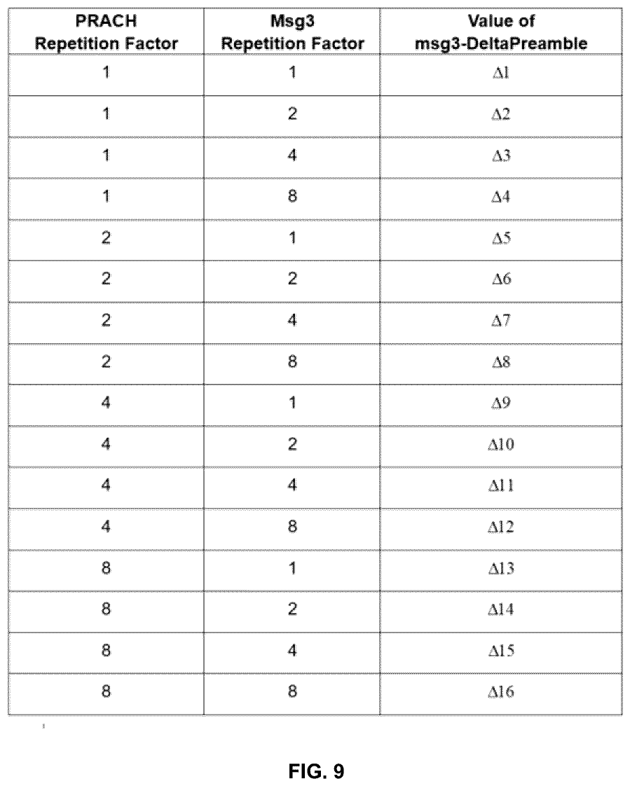

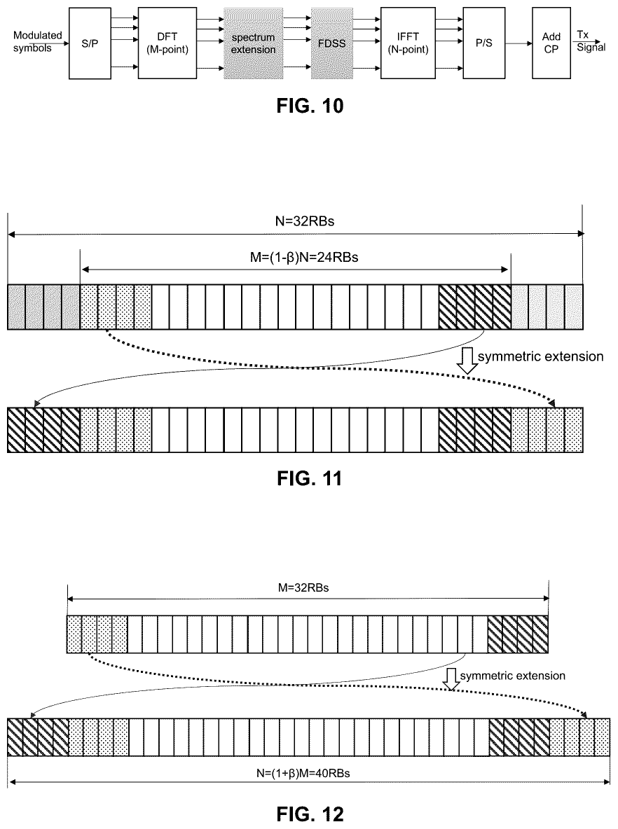

FIG. 10 is a block diagram of Discrete Fourier Transform Spread Orthogonal Frequency Division Multiplexing (DFT-S-OFDM) transmitter with FDSS and spectrum extension, according to some arrangements. The differences compared to legacy DFT-s-OFDM is shown in gray.

In some arrangements, the first step to take is the definition of the notation to be used for modeling the spectrum extension. Denote M as number of modulation constellation symbols in the units of RBs, which is also the size of DFT operation, N as the number of total number of OFDM subcarriers in the units of RBs, and E as the number of subcarriers used for spectrum extension in the units of RBs. Thus the extension factor (denoted as B) can be defined in the following two ways, Definition 1 and Definition 2.

Definition 1: the extension factor (β) is given spectrum extension size/Total allocation size, that is β=E/N.

Definition 2: the extension factor (β) is given spectrum extension size/Modulation constellation symbol size, that is β=E/M.

Currently, the frequency-domain resource allocation is indicated by the scheduling grant or higher layer configuration. When FDSS with spectrum extension is introduced, the UE interprets the frequency domain resource allocation includes Interpretation 1 Interpretation 2.

Interpretation 1: the UE interprets the frequency domain resource allocation as the total number of OFDM subcarriers (N), which includes spectrum extension part.

Interpretation 2: the UE interprets the frequency domain resource allocation as the number of modulation constellation symbols (M), which excludes the spectrum extension part.

The definition of extension factor should be aligned with the interpretation of the frequency domain resource allocation. If the UE interprets the frequency domain resource allocation as the total number of OFDM subcarriers (N), Definition 1 should be used, otherwise, definition 2 should be used instead. In the following, an example is given to illustrate the differences between these two cases. Assume the frequency domain resource allocation indicates that the UE is allocated with 32 continuous RBs, and the extension factor β is 0.25. There are 12 subcarriers in one RB. Then the two cases would be shown in FIG. 11 and FIG. 12 respectively.

FIG. 11 is a diagram illustrate an example of resources, according to various arrangements. In FIG. 11, Interpretation 1 and Definition 1 are implemented. The total number of OFDM subcarriers N is 32, then the number of subcarriers used for spectrum extension is E=β*N=0.25*32=8, and the number modulation constellation symbols as well as the DFT size can be M=(1−β)*N=(1−0.25)*32=24.

FIG. 12 is a diagram illustrate an example of resources, according to various arrangements. In FIG. 12, Interpretation 2 and Definition 2 are implemented. The number modulation constellation symbols (as well as the DFT size) M is 32, then the number of subcarriers used for spectrum extension is E=β*M=0.25*32=8. The total number of OFDM subcarriers N can be N=(1+β)*M=(1+0.25)*32=40.

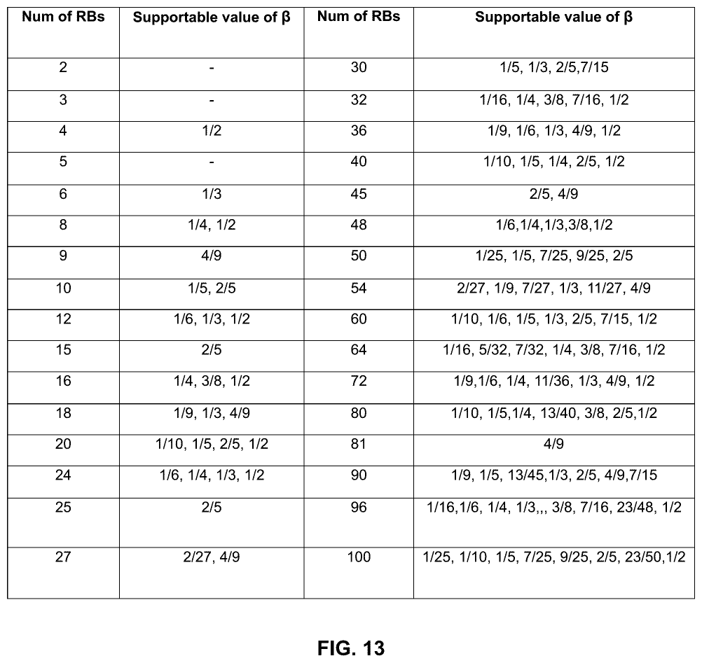

In some arrangements, there is a restriction that the spectrum extension size E should be expressed in integer units of RBs. These would limit the possible values of extension factor α. In case that interpretation 1 and definition 1 is adopted for FDSS with spectrum extension, there is also a restriction that the value of M should also expressed in integer units of RBs that can be divided by 2^{α2*}3^{α3*}5^{α5,}, where α₂, α₃, α₅ is a set of non-negative integers. In current NR specification, FDSS with spectrum extension is not adopted, thus the frequency domain resource allocation for DFT-s-OFDM should follow the principle that the resource allocation. That is, the value N in the units of RBs is also a multiple of 2^{α2*}3^{α3*}5^{α5}. FIG. 13 is a table listing the possible values of extension factor that can be configured for the different value of N (in the units of RBs), according to various arrangements. Note that extension factor larger than 0.5 is not considered in the table shown in FIG. 13 because larger extension factor leads to higher code rate for data transmission which would degrade the link level performance.

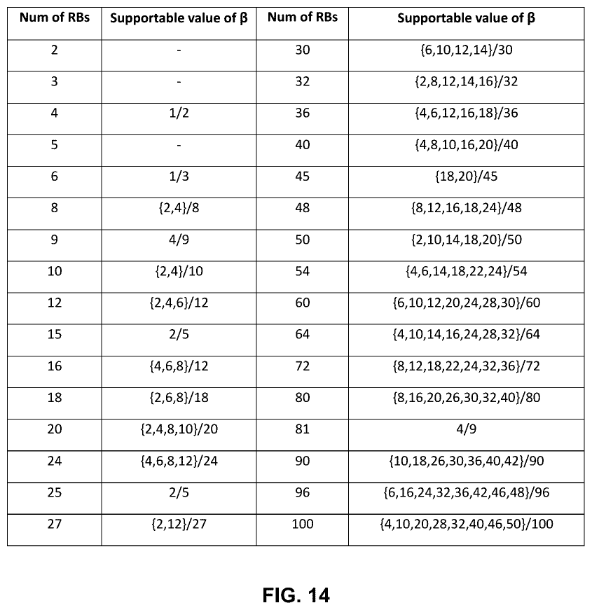

In some examples, FIG. 13 can also be in another format, such as that shown in FIG. 14. FIG. 14 is a table listing lists the possible values of extension factor that can be configured for the different value of N (in the units of RBs), according to various arrangements.

For Interpretation 2 and Definition 2, the frequency domain resource allocation equals to the value of M, and the value of M does not depend on the extension factor. Thus the extension factor should be set to satisfy the requirement of “spectrum extension size E should be expressed in integer units of RBs”. If symmetric extension is adopted, the above requirement should be modified as “spectrum extension size E should be expressed in even integer units of RBs”. The extension factor shown in Table-1 assumes symmetric extension is used.

With the restriction of “spectrum extension size E should be expressed in integer units of RBs” or “spectrum extension size E should be expressed in even integer units of RBs”, when determining the spectrum extension side, E can be calculated by at least one of the following. In some arrangements, for Definition 1:

$$E = ceil ( β * N ) \qquad ( 1 )$$

$$E = ceil ( β * N / 2 ) * 2. \qquad ( 2 )$$

$$\begin{matrix}If floor ( β * N ) > 0 , & then E = round ( β * N )\end{matrix} \qquad ( 3 )$$

$$\begin{matrix}If floor ( β * N / 2 ) > 0 , & then E = round ( β * N / 2 )\end{matrix} * 2 \qquad ( 4 )$$

For Definition 2, use M instead of N in the above formula.

In some examples, “ceil” refers to a round up operation, and “floor” refers to round down operation.

In some arrangements, there are several options to indicate the extension factor. The options include but not limit to:

Option 1: a predefined value for a given N_RB.

Option 2: RRC configured

Option 3: RRC configured and DCI indicated. Regarding the DCI indication, following should be considered.

Option 3-1: new DCI field

Option 3-2: reuse existing DCI field.

In Option 1, when the UE gets the frequency domain resource allocation, regardless the UE interprets it into M or N, an extension factor can be obtained accordingly. The relationship between the number of RB allocated (N_RB) and the extension factor is predefined, and both UE and gNB have the common understanding. The extension factor for a given N_RB can be set based on large amount of simulations to find the optimal value of extension factor to achieve the best performance. This option is most simple but least flexibility.

In Option 2, the extension factor can be configured by RRC signaling. In one embodiment, the extension factor can be configured in pusch-Config or ConfiguredGrantConfig. And the reconfiguration of extension factor can be achieved by RRC reconfiguration. In this way, considerable flexibility can be achieved.

In Option 3, multiple extension factors are configured by RRC. Similar as Option 2, the multiple extension factors can be configured in pusch-Config or ConfiguredGrantConfig. And for a given PUSCH transmission, the used extension factor is indicated through the scheduling DCI or activation DCI for the corresponding PUSCH transmission.

Regarding the DCI indication, in some arrangements, a new DCI field indicating the extension factor is introduced in the DCI. The size of the new control field depends on the number of extension factors configured in RRC. In some arrangements, 2 bits are introduced for extension factor indication, then at most 4 extension factors can be configured in RRC.

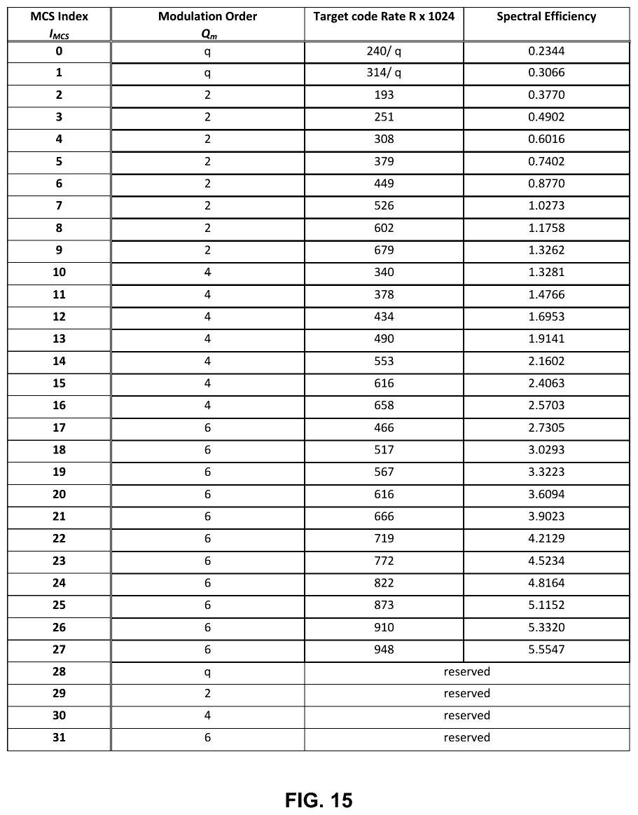

In some arrangements, the extension factor can be indicated by reusing the existing DCI field. For example, the extension factor can be indicated by the MCS index control field. FIG. 15 is a table illustrating the MCS index table for PUSCH with transform precoding (also known as DFT-s-OFDM PUSCH), according to various arrangements. Considering in uplink coverage limited scenarios, low MCS index would be used. In this case, if the MCS index used for FDSS with spectrum extension is limited to 0˜7, only 3 LSB is enough for MCS indication, then the two MSB in MCS control field can be reused to indicate the extension factor. Then one of the 4 RRC configured extension factors can be indicated by the 2 MSB in MCS control field. In this case, the UE should know whether it should reinterpret the MCS control field. In some arrangements, if FDSS with spectrum extension is configured for the UE, it should reinterpret the MCS field. Only the 3 LSB is used to indicate the MCS index, and the 2 MSB is used to indicate the extension factor.

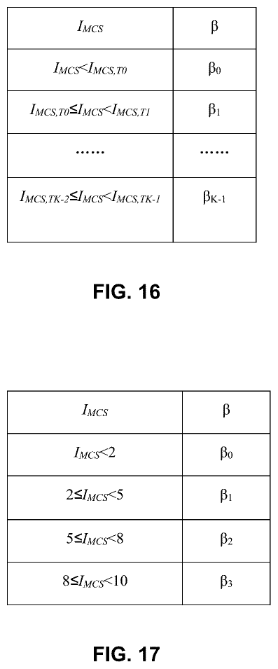

In some arrangements, the extension factor can derived from the MCS index implicitly. Based on some preliminary evaluation results, for lower MCS index (corresponding to lower code rate), larger extension factor can be used. In this case, suppose the number of extension factors configured in RRC is K and the extension factors are configured in an decreasing order, that is, β₀>β₁>β₂> . . . >β_{K-1}. K MCS index thresholds are predefined. For a given MCS index I_{MCS}, the extension factor β can be obtained based on FIG. 16.

As an example, considering FDSS with spectrum extension only applicable for pi/2-BPSK and QPSK, then the MCS index would be 0˜9. In some arrangements, assuming 4 extension factors are configured in RRC, then the extension factor β can be obtained based on FIG. 17.

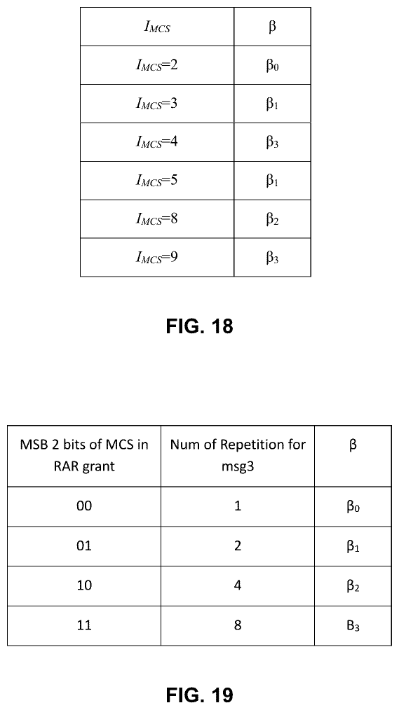

In some arrangements, the extension factor can be derived from the MCS index by RRC configuration for at least one MCS index I_{MCS}. For the MCS index I_{MCS} without configuration of extension factor, no FDSS with spectrum extension is applied. Considering FDSS with spectrum extension only applicable for pi/2-BPSK and QPSK, then the MCS index would be 0˜9. Assuming 4 extension factors are configured in RRC, then the extension factor β can be obtained based on FIG. 18. For I_{MCS}=2, β₀ is applied, while for I_{MCS}=6, no FDSS with spectrum extension is applied.

In some arrangements, the extension factor can be derived by existing field with enhancement (e.g. configure another column of TDRA table to represent the extension factor), or new field. And whether the FDSS with spectrum extension is applied depends on two fields, that is the MCS field with specified I_{MCS} and the above field for extension factor indication with a valid extension factor. Assume specified I_{MCS} are MCS index 0˜7. For example, one DCI with the MCS index I_{MCS}=2 and one row indicated of the TDRA table also configured the extension factor, then the FDSS with spectrum extension is applied. For another example, one DCI with the MCS index I_{MCS}=2 and one row indicated of the TDRA table without configured the extension factor, then the FDSS with spectrum extension is not applied. For another example, one DCI with the MCS index I_{MCS}=10 and one row indicated of the TDRA table with configured the extension factor, then the FDSS with spectrum extension is not applied. For another example, one DCI with the MCS index I_{MCS}=10 and one row indicated of the TDRA table without configured the extension factor, then the FDSS with spectrum extension is not applied.

In some arrangements, the extension factor can be derived by SIBx and/or RAR grant for msg3/5 (re) transmission. For example, the extension factor can be derived by SIBx indication, and optionally only applied for msg3/5 and/or applied until UE-specific RRC configuration received. For another example, the extension factor can be derived by RAR grant indication, and optionally the candidates extension factors can be predefined or indicated by SIBx, optionally one or more fields (e.g., the MSB X bit(s) of MCS field) in RAR grant can be represented to indicate the extension factor. In case the repetition number of msg3 is also needed to be indicated, a code-point table (e.g., FIG. 19) could be configured, the first column is the number of repetition, the second column is the extension factor.

In some arrangements, the extension factor can be derived by existing field with enhancement (e.g., using MSB X bit(s) of MCS field represent the extension factor), or new field in DCI format 0_0. The new field for the extension factor indication locates before padding, or locates after padding bit(s) and in the second or third last bits before UL/SUL indicator and/or Waveform indicator, if the number of bits for DCI format 1_0 before padding is larger than the number of bits for DCI format 0_0 before padding.

In some arrangements, in case retransmission of msg3 or transmission/retransmission of msg5 scheduled by DCI format 0_0, the extension factor can be derived by indication of format 0_0, Optionally the indicated extension factor should be same as the extension factor for the previous transmission of the same TB or msg3 initial transmission. Or the extension factor can be implicitly derived by the previous transmission of the same TB or msg3 initial transmission, and discard the indication of format 0_0.

While various arrangements of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one arrangement can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed:

1. A wireless communication method, comprising:
determining, by a wireless communication device, a transmission power for multiple Physical Random Access Channel (PRACH) transmissions in a PRACH transmission bundle; and
transmitting, by the wireless communication device to a base station, the multiple PRACH transmissions using the transmission power.

2. The wireless communication method of claim 1, wherein
the multiple PRACH transmissions comprise an initial PRACH transmission and at least one repetition or at least one retransmissions of the initial PRACH transmission in the same PRACH transmission bundle.

3. The wireless communication method of claim 1, wherein
determining the transmission power for the multiple PRACH transmissions comprises receiving, by the wireless communication device from the base station, an indication of a configured target reception power for the multiple PRACH transmissions; and
transmitting the multiple PRACH transmissions using the transmission power comprises transmitting the multiple PRACH transmissions according to the transmission power determined based on the configured target reception power for the multiple PRACH transmissions.

4. The wireless communication method of claim 3, wherein the configured target reception power for the multiple PRACH transmissions comprises:
a same configured target reception power configured for multiple repetition factors, each of the multiple repetition factors indicates a different number of transmissions of the multiple PRACH transmissions in the PRACH transmission bundle; or
a target configured reception power configured for each of the multiple repetition factors of the multiple PRACH transmissions.

5. The wireless communication method of claim 1, wherein
the transmission power for the multiple PRACH transmissions is determined using a set of delta values for the multiple PRACH transmissions, the set of delta values corresponding to preamble formats; and
transmitting the multiple PRACH transmissions using the transmission power comprises transmitting the multiple PRACH transmissions according to the transmission power determined based on the set of delta values.

6. The wireless communication method of claim 5, comprising determining the set of delta values for the multiple PRACH transmissions using a set of delta values for a single PRACH transmission in a PRACH transmission bundle and an offset.

7. The wireless communication method of claim 5, wherein the set of delta values for the multiple PRACH transmissions comprises:
a same set of delta values configured for multiple repetition factors, each of the multiple repetition factors indicates a different number of transmissions of the multiple PRACH transmissions in the PRACH transmission bundle; or
a set of delta values configured for each of the multiple repetition factors of the multiple PRACH transmissions.

8. The wireless communication method of claim 1, wherein
the transmission power for the multiple PRACH transmissions is determined using a power offset for the multiple PRACH transmissions; and
transmitting the multiple PRACH transmissions using the transmission power comprises transmitting the multiple PRACH transmissions according to the transmission power determined based on the power offset.

9. The wireless communication method of claim 8, wherein the power offset for the multiple PRACH transmissions comprises:
a same power offset configured for multiple repetition factors, each of the multiple repetition factors indicates a different number of transmissions of the multiple PRACH transmissions in the PRACH transmission bundle; or
a power offset configured for each of the multiple repetition factors of the multiple PRACH transmissions.

10. The wireless communication method of claim 1, wherein the transmission power for the multiple PRACH transmissions is determined using a repetition factor for the multiple PRACH transmissions, wherein the repetition factor indicates a number of transmissions of the multiple PRACH transmissions in the PRACH transmission bundle.

11. The wireless communication method of claim 1, wherein the transmission power for the multiple PRACH transmissions is determined using a first power ramping counter and a second power ramping counter, the first power ramping counter counts a current number of the multiple PRACH transmissions, and the second power ramping counter counts a current number of PRACH transmission bundles.

12. The wireless communication method of claim 1, wherein the transmission power for the multiple PRACH transmissions is determined using a first power ramping step size and a second power ramping step size, the first power ramping step size is a difference between two adjacent PRACH transmissions within the PRACH transmission bundle, and the second power ramping step size is a difference between a first PRACH transmission in the PRACH transmission bundle and a second PRACH transmission in another PRACH transmission bundle.

13. The wireless communication method of claim 1, wherein determining the transmission power comprises:
determining that a measurement result is less than a threshold; and
in response to determining that the measurement result is less than the threshold, determining to send the multiple PRACH transmissions in the PRACH transmission bundle using a maximum transmit power.

14. The wireless communication method of claim 1, comprising determining a transmission power for an uplink transmission according to a transmission power used to transmit a last PRACH transmission of the multiple PRACH transmissions in the PRACH transmission bundle.

15. The wireless communication method of claim 1, comprising determining a transmission power for an uplink transmission according to an indication received from a base station indicating one of multiple transmission powers used to transmit the multiple PRACH transmissions in the PRACH transmission bundle.

16. The wireless communication method of claim 1, comprising:
receiving from the base station an offset between a transmission power of one of the multiple PRACH transmissions and a transmission power for an uplink transmission, the offset is mapped to a repetition factor of the multiple PRACH transmissions and a repetition factor of the uplink transmission; and
determining the transmission power for the uplink transmission based on the transmission power of the one of the multiple PRACH transmissions and the offset.

17. The wireless communication method of claim 1, comprising:
determining a scaling factor based on a repetition factor of the multiple PRACH transmissions and a repetition factor of an uplink transmission; and
determining the transmission power for the uplink transmission based on the transmission power of the one of the multiple PRACH transmissions and the scaling factor.

18. A wireless communication device, comprising:
at least one processor configured to:
determine a transmission power for multiple Physical Random Access Channel (PRACH) transmissions in a PRACH transmission bundle; and
transmit, via a transmitter to a base station, the multiple PRACH transmissions using the transmission power.

19. A wireless communication method, comprising:
receiving, by a base station from a wireless communication device, multiple Physical Random Access Channel (PRACH) transmissions in a PRACH transmission bundle, using a transmission power,
wherein the transmission power for the multiple PRACH transmissions is determined by the wireless communication device.

20. A base station, comprising:
at least one processor configured to:
receive, via a receiver from a wireless communication device, multiple Physical Random Access Channel (PRACH) transmissions in a PRACH transmission bundle, using a transmission power,
wherein the transmission power for the multiple PRACH transmissions is determined by the wireless communication device.
